(19) United States
(12) Patent Application Publication
(10) Pub. No.: US 2026/0221656 A1
(43) Pub. Date: Jul. 30, 2026

(54) ANTENNA MODULE AND COMMUNICATION DEVICE EQUIPPED THEREWITH

(71) Applicant: Murata Manufacturing Co., Ltd., Nagaokakyo-shi (JP)

(72) Inventor: Natsumi MINAMITANI, Nagaokakyo-shi (JP)

(73) Assignee: Murata Manufacturing Co., Ltd., Nagaokakyo-shi (JP)

(21) Appl. No.: 19/572,903

(22) Filed: Mar. 20, 2026

Related U.S. Application Data
(63) Continuation of application No. PCT/JP2024/029055, filed on Aug. 15, 2024.

(30) Foreign Application Priority Data
Sep. 28, 2023 (JP) 2023-168456

(51) Int. Cl. H01Q 9/04; H01Q 1/22

(52) U.S. Cl. CPC H01Q 9/045; H01Q 1/2283

(57) ABSTRACT

An antenna module includes a dielectric substrate, a radiating element having a planar shape, a ground electrode, a feed line, and an auxiliary electrode. The dielectric substrate has first and second main surfaces facing each other. The ground electrode is disposed on the second main surface and faces the radiating element. The feed line transmits a radio-frequency signal to a feed point of the radiating element. The auxiliary electrode is connected to the feed line and is disposed between the radiating element and the ground electrode. The feed point is disposed at a position offset from the center of the radiating element in a first direction. When viewed in plan from the normal direction of the dielectric substrate, the auxiliary electrode protrudes from the radiating element toward the first direction.

### CROSS-REFERENCE TO RELATED APPLICATIONS

This application is a continuation of International Application No. PCT/JP2024/029055, filed on Aug. 15, 2024, which claims the benefit of priority to Japanese Patent Application No. 2023-168456, filed on Sep. 28, 2023. The entire contents of each of these applications are hereby incorporated by reference.

### TECHNICAL FIELD

The present disclosure relates to an antenna module and a communication device equipped therewith, and more particularly to techniques for improving the directivity of an antenna compatible with radio-frequency signals in the sub-terahertz frequency band.

### BACKGROUND ART

International Publication No. WO 2014/045966 (Patent Document 1) discloses a configuration in which a high-frequency signal is supplied to a patch antenna through a stripline and a via.

### CITATION LIST

### Patent Document

Patent Document 1: International Publication No. WO 2014/045966

### SUMMARY

An antenna module according to the present disclosure includes a dielectric substrate, a first radiating element having a planar shape, a ground electrode, a first feed line, and a first electrode having a planar shape. The dielectric substrate has a first main surface and a second main surface facing each other. The first radiating element is disposed in or on the dielectric substrate. The ground electrode is disposed on the second main surface side of the dielectric substrate relative to the first radiating element, facing the first radiating element. The first feed line transmits a radio-frequency signal to a first feed point of the first radiating element. The first electrode is connected to the first feed line and is disposed between the first radiating element and the ground electrode. The first feed point is disposed at a position offset from a center of the first radiating element in a first direction. When viewed in plan from a normal direction of the dielectric substrate, the first electrode protrudes from the first radiating element toward the first direction.

### BRIEF DESCRIPTION OF DRAWINGS

FIG. 1 is an overall configuration diagram of a communication device to which an antenna module according to Embodiment 1 is applied.

FIG. 2 is a perspective view illustrating an internal structure of the antenna module according to Embodiment 1.

FIG. 3 includes a plan view and a side transparent view of the antenna module illustrated in FIG. 2.

FIG. 4 is a diagram illustrating an example of the electromagnetic field distribution and antenna gain of the antenna modules according to Embodiment 1 and a comparative example.

FIG. 5 is a diagram for explaining the antenna gain when the width of an auxiliary electrode is changed.

FIG. 6 is a side transparent view of an antenna module according to Embodiment 2.

FIG. 7 is a side transparent view of an antenna module according to Embodiment 3.

FIG. 8 is a perspective view of an antenna module according to Embodiment 4.

FIG. 9 is a perspective view of an antenna module according to Embodiment 5.

FIG. 10 is a plan view of an antenna module according to Embodiment 6.

FIG. 11 is a plan view of an antenna module of Modification 1.

FIG. 12 is a plan view of an antenna module of Modification 2.

FIG. 13 is a plan view of an antenna module according to Embodiment 7.

FIG. 14 is a side transparent view of an antenna module according to Embodiment 8.

FIG. 15 is a perspective view of an antenna module according to Embodiment 9.

FIG. 16 is a side transparent view of an antenna module according to Embodiment 10.

FIG. 17 is a side transparent view of an antenna module according to Embodiment 11.

FIG. 18 is a side transparent view of an antenna module according to Embodiment 12.

### DESCRIPTION OF EMBODIMENTS

Hereinafter, embodiments of the present disclosure will be described in detail with reference to the drawings. Note that the same reference numerals are assigned to identical or corresponding portions in the drawings, and descriptions thereof are not repeated.

In recent years, development of communication in the so-called sub-terahertz frequency band exceeding 100 GHz has been progressing for wireless communication devices. Since the use of the sub-terahertz frequency band allows for wider spectral bandwidth, large-capacity and high-speed communication of 100 Gbps or more, for example, becomes possible.

The inventor has recognized that, for signals in frequency bands exceeding 100 GHz, the influence of surface waves generated on the surface of the dielectric substrate where the radiating elements are arranged tends to increase. In the case of patch antennas, since the feed point is provided at a position offset from the center element, asymmetry occurs in the electromagnetic field generated from the radiating element. As the influence of surface waves increases as described above, the asymmetry of the electromagnetic field becomes more pronounced, making it more likely that the beam direction (directivity) of the radiated radio waves will tilt. This, in turn, may cause a decrease in antenna gain in the desired radiation direction.

In an antenna module according to the present disclosure, a planar electrode (first electrode) extending in an offset direction (first direction) of a feed point is connected to a feed line that transmits a high-frequency signal to a radiating element, and the planar electrode protrudes from the radiating element in the first direction. As a result, part of the electric field lines spreading from the radiating element in the first direction reach a ground electrode via the planar electrode.

Therefore, the electric field lines that spread from the radiating element in the first direction couple to the ground electrode at a position closer to the radiating element than in the case where the planar electrode is not provided. This suppresses the spreading of the electric field lines from the radiating element toward the first direction, thereby reducing the tilt of the beam toward the first direction. Accordingly, the directivity of the antenna module may be improved.

### Embodiment 1

### (Basic Configuration of Communication Device)

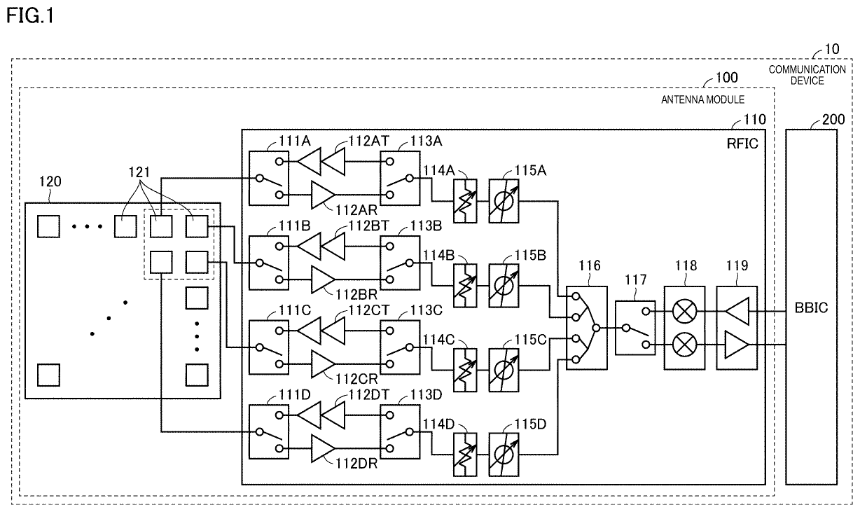

FIG. 1 is an example of a block diagram of a communication device 10 according to the present embodiment. The communication device 10 is, for example, a mobile terminal such as a mobile phone, smartphone, or tablet, a personal computer equipped with a communication function, or a base station. The frequency band of radio waves used for an antenna module 100 according to the present embodiment is the so-called sub-terahertz frequency band, i.e., radio waves exceeding 100 GHz.

Referring to FIG. 1, the communication device 10 includes the antenna module 100, and a BBIC 200 that constitutes a baseband signal processing circuit. The antenna module 100 includes an RFIC 110, which is an example of a feed circuit, and an antenna device 120. The communication device 10 up-converts a signal transmitted from the BBIC 200 to the antenna module 100 into a radio-frequency signal and radiates it from the antenna device 120. The communication device 10 also down-converts a radio-frequency signal received at the antenna device 120 and processes the signal in the BBIC 200. The functionality of the elements disclosed herein (e.g., BBIC 200, RFIC 110) may be implemented using processing circuitry which includes general purpose processors, special purpose processors, and/or ASICs configured to perform the disclosed functionality.

In FIG. 1, for ease of explanation, only the configurations corresponding to four of multiple radiating elements 121 that constitute the antenna device 120 are illustrated; configurations corresponding to other radiating elements 121 having the same configurations are not repeated. Although FIG. 1 illustrates an example in which the antenna device 120 is formed by multiple radiating elements 121 arranged in a two-dimensional array, the radiating elements 121 do not necessarily need to be multiple; the antenna device 120 may instead be formed with only a single radiating element 121. The radiating elements 121 may also form a one-dimensional array disposed in a single row. In Embodiment 1, each of the radiating elements 121 is described using a patch antenna having an approximately square planar shape as an example; however, the shape of each radiating element 121 may alternatively be circular, elliptical, or another polygon such as a hexagon.

The RFIC 110 includes switches 111A to 111D, 113A to 113D, and 117, power amplifiers 112AT to 112DT, low-noise amplifiers 112AR to 112DR, attenuators 114A to 114D, phase shifters 115A to 115D, a signal combiner/splitter 116, a mixer 118, and an amplification circuit 119.

When transmitting a radio-frequency signal, the switches 111A to 111D and 113A to 113D are switched to the power amplifiers 112AT to 112DT side, and the switch 117 is connected to the transmission-side amplifier of the amplification circuit 119. When receiving a radio-frequency signal, the switches 111A to 111D and 113A to 113D are switched to the low-noise amplifiers 112AR to 112DR side, and the switch 117 is connected to the reception-side amplifier of the amplification circuit 119.

A signal transmitted from the BBIC 200 is amplified by the amplification circuit 119 and up-converted by the mixer 118. The up-converted radio-frequency signal, which is the transmission signal, is divided into four paths by the signal combiner/splitter 116 and supplied to the different radiating elements 121 through the four respective signal paths. At this time, by individually adjusting the phase shift amounts of the phase shifters 115A to 115D disposed in the respective signal paths, it is possible to adjust the directivity of the antenna device 120. Additionally, the attenuators 114A to 114D adjust the magnitude of the transmission signals.

Reception signals, which are radio-frequency signals received by the individual radiating elements 121, follow the four separate signal paths and are combined by the signal combiner/splitter 116. The combined reception signal is down-converted by the mixer 118, amplified by the amplification circuit 119, and transmitted to the BBIC 200.

The RFIC 110 may be formed, for example, as a single-chip integrated circuit component incorporating the above-described circuit configuration. Alternatively, devices (switches, power amplifiers, low-noise amplifiers, attenuators, and phase shifters) in the RFIC 110 that correspond to the respective radiating elements 121 may each be formed as a single-chip integrated circuit component for each corresponding radiating element 121.

### (Configuration of Antenna Module)

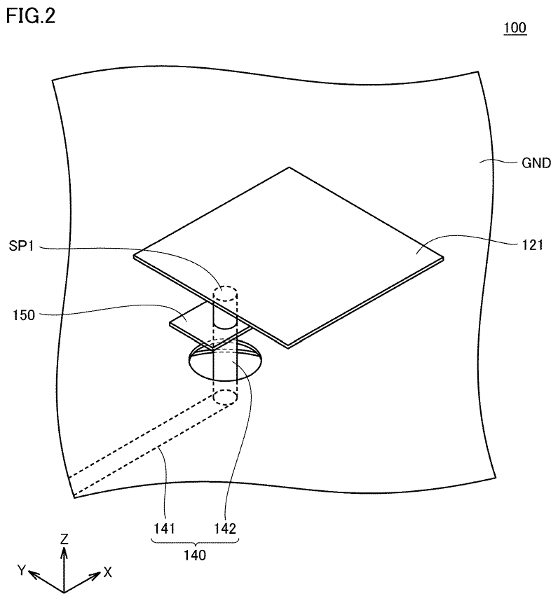

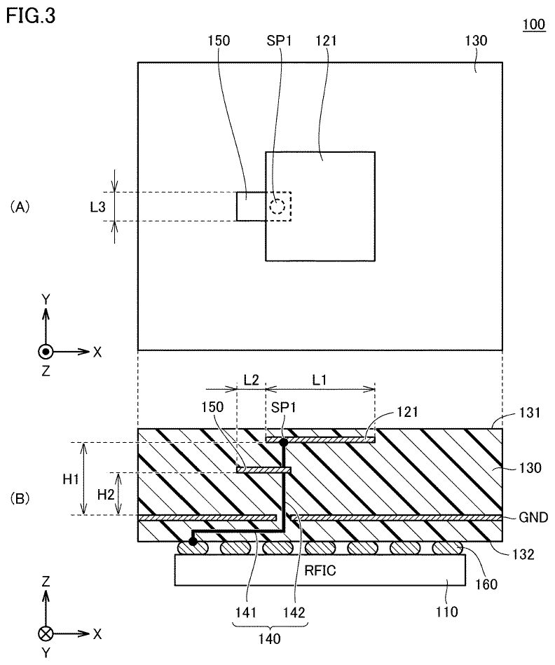

Next, using FIGS. 2 and 3, the configuration of the antenna module 100 according to Embodiment 1 will be described in detail. FIG. 2 is a perspective view illustrating an internal structure of the antenna module 100. FIG. 3 includes a plan view (upper diagram (A)) and a side transparent view (lower diagram (B)) of the antenna module 100.

Referring to FIGS. 2 and 3, the antenna module 100 includes, in addition to the radiating elements 121 and the RFIC 110, a dielectric substrate 130, a ground electrode GND, a feed line 140, and an auxiliary electrode 150. Note that, in FIG. 2 and the subsequent perspective views, the dielectric member of the dielectric substrate 130 on which each element is disposed is omitted for clarity in order to describe the internal structure.

The dielectric substrate 130 has a substantially rectangular-parallelepiped shape that includes two rectangular main surfaces 131 and 132 facing each other. In the following description, the normal direction of the main surfaces 131 and 132 of the dielectric substrate 130 is defined as the Z-axis direction. A direction along one side of each main surface of the dielectric substrate 130 is defined as the X-axis direction, and a direction along the other side is defined as the Y-axis direction. Additionally, in the drawings, the positive Z-axis direction may also be referred to as the upper side, and the negative Z-axis direction as the lower side.

The dielectric substrate 130 may be, for example, a low temperature co-fired ceramics (LTCC) multilayer substrate, a multilayer resin substrate formed by laminating multiple resin layers composed of epoxy, polyimide, or other resins, a multilayer resin substrate formed by laminating multiple resin layers composed of liquid crystal polymer (LCP), which has a lower dielectric constant, a multilayer resin substrate formed by laminating multiple resin layers composed of fluororesin, a multilayer resin substrate formed by laminating multiple resin layers composed of polyethylene terephthalate (PET) material, or a ceramic multilayer substrate other than LTCC. Note that the dielectric substrate 130 need not necessarily have a multilayer structure and may instead be a single-layer substrate.

When viewed in plan from the normal direction (Z-axis direction), the dielectric substrate 130 has a rectangular shape. The radiating element 121 is disposed at a position near the upper main surface 131 of the dielectric substrate 130. The radiating element 121 may be disposed to be exposed on the surface of the dielectric substrate 130, or it may be embedded in an internal layer of the dielectric substrate 130, as illustrated in the example of FIG. 3.

In the dielectric substrate 130, the ground electrode GND is disposed over the entire surface on the main surface 132 side relative to the radiating element 121, facing the radiating element 121. On the main surface 132 of the dielectric substrate 130, the RFIC 110 is mounted with solder bumps 160 interposed therebetween. Alternatively, the RFIC 110 may be connected to the dielectric substrate 130 using a multi-pole connector instead of soldering.

A radio-frequency signal is supplied from the RFIC 110 to a feed point SP1 of the radiating element 121 through the feed line 140. The feed line 140 includes a wiring pattern 141 extending from the solder bump 160 in the X-axis direction, and a via 142 extending from the end portion of the wiring pattern 141 in the Z-axis direction. The via 142 penetrates the ground electrode GND and is connected to the feed point SP1 of the radiating element 121. The feed point SP1 is offset from the center of the radiating element 121 in the negative X-axis direction (first direction). By supplying a radio-frequency signal to the feed point SP1, the radiating element 121 radiates radio waves, polarized in the X-axis direction, in the Z-axis direction.

The auxiliary electrode 150 is a planar electrode having a rectangular shape. The auxiliary electrode 150 is connected to the via 142 of the feed line 140 and is disposed between the radiating element 121 and the ground electrode GND. When viewed in plan from the normal direction of the dielectric substrate 130, the auxiliary electrode 150 extends in the negative X-axis direction from the position where it is connected to the via 142, and protrudes from the end portion of the radiating element 121 in the negative X-axis direction.

### (Directivity)

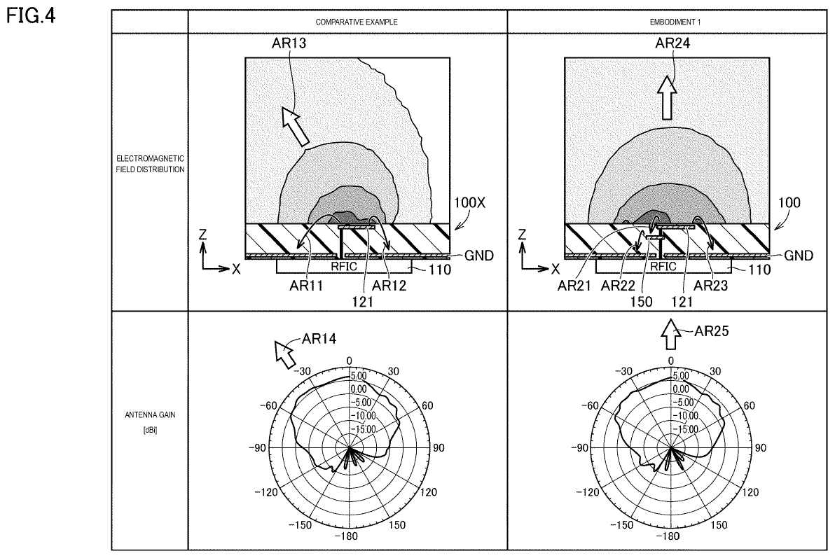

Next, using FIG. 4, the directivity of the antenna module and the functions of the auxiliary electrode 150 will be described. In FIG. 4, examples of the electromagnetic field distribution (upper row) and antenna gain (lower row) on the ZX plane are indicated for the antenna module 100 of Embodiment 1 and an antenna module 100X of a comparative example. Note that, in the antenna module 100X, the auxiliary electrode 150 included in the antenna module 100 is not provided.

In general, in an antenna module having a patch antenna, when a radio-frequency signal is supplied to the radiating element 121 through the feed line 140, electromagnetic coupling occurs between the radiating element 121 and the ground electrode GND due to a fringing effect. At this time, when a signal in the sub-terahertz frequency band exceeding 100 GHz is supplied as a radio-frequency signal, the influence of surface waves generated on the surface of the dielectric substrate 130 becomes significant, and electric field lines tend to spread in a direction along the surface of the radiating element 121 (i.e., the polarization direction). In particular, in an asymmetric configuration in which a feed point is offset, such as in a patch antenna, as illustrated in the comparative example of FIG. 4, electric field lines (arrow AR11) generated in the negative X-axis direction, which are closer to the feed point, couple to the ground electrode GND at a position farther from the radiating element 121 than electric field lines (arrow AR12) generated in the positive X-axis direction.

Consequently, the electromagnetic field distribution generated by radio waves radiated from the radiating element 121 becomes a distribution tilted from the Z-axis direction (that is, the normal direction of the radiating element 121) toward the negative X-axis direction, as indicated by arrow AR13. As a result, the beam pattern generated by the radiating element 121 also tilts from the Z-axis direction toward the negative X-axis direction (arrow AR14), thereby potentially degrading directivity.

In contrast, in the antenna module 100 of Embodiment 1, electric field lines generated from the end portion of the radiating element 121 in the negative X-axis direction are guided to the ground electrode GND through the auxiliary electrode 150 connected to the via 142 of the feed line 140 (arrows AR21 and AR22). This allows the radiating element 121 and the ground electrode GND to couple at a position closer to the radiating element 121, as compared with the antenna module 100X of the comparative example. Therefore, by appropriately adjusting the dimension and position of the auxiliary electrode 150, it is possible to allow the radiating element 121 and the ground electrode GND to couple at substantially an equivalent distance as the electric field lines generated from the end portion in the positive X-axis direction (arrow AR23). As a result, the tilt of the electromagnetic field distribution caused by radio waves radiated from the radiating element 121 is reduced, as indicated by arrow AR24 in FIG. 4, and the beam pattern becomes aligned with the Z-axis direction (arrow AR25). Thus, even when using signals in the sub-terahertz frequency band, it is possible to improve the directivity of the antenna module by providing the auxiliary electrode 150.

To enable the auxiliary electrode 150 to function as described above, it is necessary to appropriately set the dimension and disposition of the auxiliary electrode 150.

For example, a protrusion amount L2 of the auxiliary electrode 150 from the radiating element 121 may be set to be less than or equal to one-half of a dimension L1 of the radiating element 121 in the X-axis direction (L2/L1≤½). If the protrusion amount L2 of the auxiliary electrode 150 is excessively large, the coupling position between the electric field lines generated from the auxiliary electrode 150 and the ground electrode GND becomes distant from the radiating element 121. Therefore, the effect of the auxiliary electrode 150 is eliminated. In contrast, in a configuration in which no protrusion is provided, the above-described effect of guiding electric field lines does not occur.

A dimension L3 (i.e., width) of the auxiliary electrode 150 in the Y-axis direction (second direction) may be set to be one-tenth or more less and two-thirds or less of the dimension L1 of the radiating element 121 ( 1/10≤L2/L1≤⅔). If the width of the auxiliary electrode 150 is too narrow, it is unable to sufficiently receive the electric field lines from the radiating element 121, and the effect of guiding electric field lines by the auxiliary electrode 150 is unachieved, thereby resultantly making it difficult to correct the beam pattern.

On the other hand, if the width of the auxiliary electrode 150 approaches that of the radiating element 121, the auxiliary electrode 150 itself may resonate and function as part of the radiating element 121. This may eliminate the beam-pattern correction effect or may prevent the antenna from operating properly.

FIG. 5 is a diagram illustrating variations in antenna gain when the width of the auxiliary electrode 150 is changed. In the example of FIG. 5, the antenna gains are indicated when the dimension L1 of the radiating element 121 is 530 μm and the width L3 of the auxiliary electrode 150 is 150 μm, 350 μm, and 400 μm. A width L3 of 150 μm corresponds to approximately one-fifth of the dimension L1 of the radiating element 121, and a width L3 of 350 μm corresponds to approximately two-thirds of the dimension L1 of the radiating element 121. A width L3 of 350 μm is a dimension exceeding two-thirds of the dimension L1 of the radiating element 121.

As indicated in FIG. 5, when the width L3 of the auxiliary electrode 150 becomes greater than two-thirds of the dimension L1 of the radiating element 121, the beam pattern splits in the left and right directions, and the antenna gain in the Z-axis direction is significantly reduced. In other words, the antenna no longer operates normally.

Furthermore, regarding the connection position of the auxiliary electrode 150 at the via 142, it is necessary to set it within a predetermined range. If the distance between the auxiliary electrode 150 and the ground electrode GND in the Z-axis direction is defined as H2, then the auxiliary electrode 150 may be disposed such that the distance H2 is one-third or more and two-thirds or less of a distance H1 between the radiating element 121 and the ground electrode GND. If the distance H2 is too small, the auxiliary electrode 150 becomes too close to the ground electrode GND, effectively resulting in direct coupling with the ground electrode GND, thereby eliminating the effect of guiding electric field lines. Conversely, if the distance H2 is too large, the auxiliary electrode 150 becomes too close to the radiating element 121 and functions as part of the radiating element 121, thereby making it difficult to achieve the beam-pattern correction effect.

Therefore, by adjusting the dimension and disposition of the auxiliary electrode 150 within the above ranges, it becomes possible to improve the directivity of the antenna module.

As described above, by disposing an auxiliary electrode having a predetermined dimension at a via portion of a feed line that transmits a radio-frequency signal to a feed point of a patch antenna so as to protrude from a radiating element, it is possible to improve the directivity of an antenna module when using radio-frequency signals in the sub-terahertz frequency band.

The “radiating element 121” of Embodiment 1 corresponds to a “first radiating element” of the present disclosure. The “main surface 131” and “main surface 132” of Embodiment 1 correspond to a “first main surface” and a “second main surface” of the present disclosure, respectively. The “feed line 140” of Embodiment 1 corresponds to a “first feed line” of the present disclosure. The “auxiliary electrode 150” of Embodiment 1 corresponds to a “first electrode” of the present disclosure.

### Embodiment 2

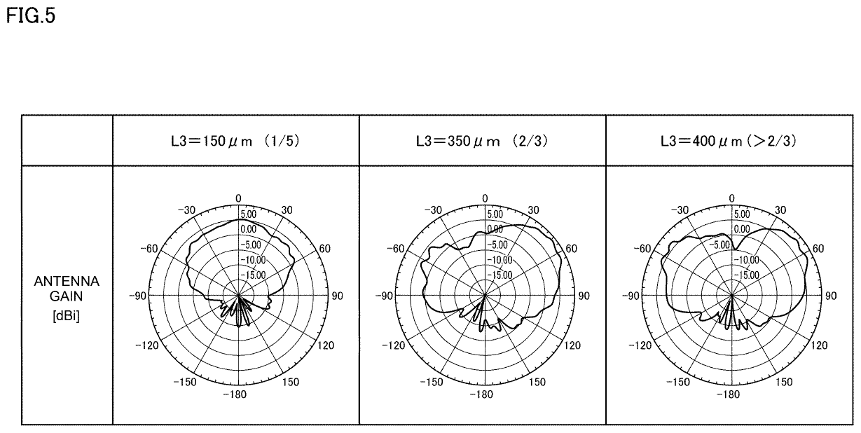

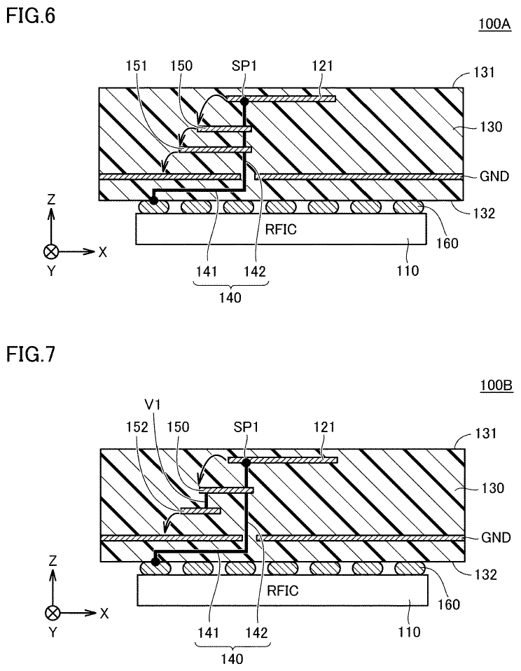

In Embodiment 2, a configuration in which multiple auxiliary electrodes are disposed will be described. FIG. 6 is a side transparent view of an antenna module 100A according to Embodiment 2. The antenna module 100A further includes an auxiliary electrode 151 in addition to the configuration of the antenna module 100 of Embodiment 1. In FIG. 6, descriptions of elements that overlap with those of the antenna module 100 are not repeated.

Referring to FIG. 6, the auxiliary electrode 151 is a planar electrode connected to the via 142 of the feed line 140, like the auxiliary electrode 150. The auxiliary electrode 151 is disposed between the auxiliary electrode 150 and the ground electrode GND in the normal direction of the dielectric substrate 130. The dimension of the auxiliary electrode 151 in the X-axis direction is longer than the dimension of the auxiliary electrode 150 in the X-axis direction. Therefore, the auxiliary electrode 151 protrudes further in the negative X-axis direction than the auxiliary electrode 150.

With this configuration, it is possible to reliably guide the electric field lines generated at the radiating element 121 to the ground electrode GND through the auxiliary electrode 150 and the auxiliary electrode 151. Therefore, it is possible to enhance the stability of the improvement in the directivity of the antenna module.

The dimension of the auxiliary electrode 151 in the Y-axis direction may be greater than or equal to the dimension of the auxiliary electrode 150 in the Y-axis direction. If the width of the auxiliary electrode 151 is narrower than that of the auxiliary electrode 150, the auxiliary electrode 151 may be unable to adequately receive the electric force lines generated from the auxiliary electrode 150. Also, as described in Embodiment 1, the width of the auxiliary electrode 151 may be less than or equal to two-thirds of the dimension L1 of the radiating element 121.

The “auxiliary electrode 151” of Embodiment 2 corresponds to a “second electrode” of the present disclosure.

### Embodiment 3

In Embodiment 3, a configuration in which the auxiliary electrode is formed by multiple electrodes will be described. FIG. 7 is a side transparent view of an antenna module 100B according to Embodiment 3. The antenna module 100B further includes an auxiliary electrode 152 and a via V1 in addition to the configuration of the antenna module 100 of Embodiment 1. In FIG. 7, descriptions of elements that overlap with those of the antenna module 100 are not repeated.

Referring to FIG. 7, in the antenna module 100B, the via V1 is connected near the end portion of the auxiliary electrode 150 in the negative X-axis direction. The via V1 extends from the auxiliary electrode 150 in the negative Z-axis direction, that is, toward the ground electrode GND. The auxiliary electrode 152 is connected to the lower end portion of the via V1.

The auxiliary electrode 152 is, for example, a planar electrode having a rectangular shape, and it extends in the negative X-axis direction from the portion where it is connected to the via V1. The auxiliary electrode 152 protrudes further in the negative X-axis direction than the auxiliary electrode 150.

With this configuration, it is possible to guide the electric field lines that the auxiliary electrode 151 has received from the radiating element 121, from the auxiliary electrode 152 to the ground electrode GND.

In the antenna module 100B, like the antenna module 100A of Embodiment 2, it is possible to reliably guide the electric field lines from the radiating element 121 to the ground electrode GND in multiple stages, thereby enhancing the stability of the improvement in the directivity of the antenna module.

Note that, when compared with the antenna module 100A of Embodiment 2, in the antenna module 100B, the auxiliary electrode 152 is connected to the auxiliary electrode 150 with the via V1 interposed therebetween, and the auxiliary electrode 150 and the auxiliary electrode 152 together function as a single auxiliary electrode. Therefore, it is possible to adjust the electric field more gently, making this configuration suitable for fine-tuning.

Additionally, since the auxiliary electrode 152 is disposed in a layer between the radiating element 121 and the ground electrode GND, it may have a non-negligible impact on the operation of the antenna. Because the auxiliary electrode 152 has a smaller electrode size than the auxiliary electrode 151 of the antenna module 100A, the auxiliary electrode 152 is able to reduce the impact on the operation of the antenna, as compared with that of the auxiliary electrode 151.

In contrast, in the case of the antenna module 100A of Embodiment 2, since the auxiliary electrode 150 and the auxiliary electrode 151 are independent of each other, it is possible to set the variation in the electric field larger than that in the antenna module 100B of Embodiment 3. That is, the configuration of the antenna module 100A is suitable for making rough adjustments to the electric field.

Which of the configurations of the antenna module 100A and the antenna module 100B is adopted is appropriately selected according to the desired requirements and the magnitude of the electric field to be varied.

The “auxiliary electrode 152” of Embodiment 3 corresponds to a “third electrode” of the present disclosure. The “via V1” of Embodiment 3 corresponds to a “first via” of the present disclosure.

### Embodiment 4

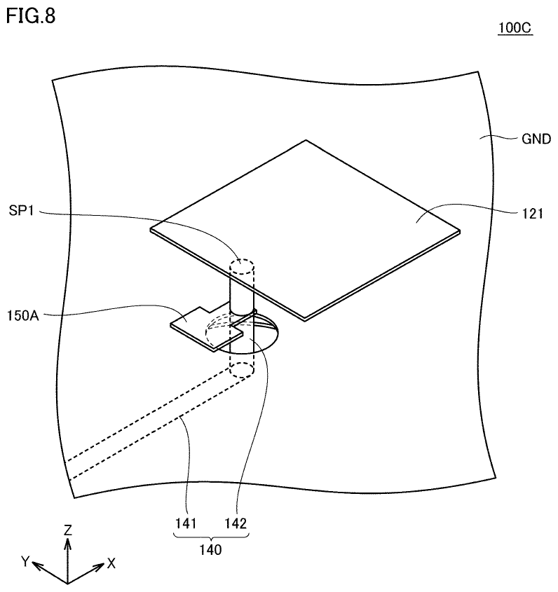

In Embodiment 4, a modification of the shape of the auxiliary electrode will be described. FIG. 8 is a perspective view of an antenna module 100C according to Embodiment 4. The antenna module 100C includes an auxiliary electrode 150A in place of the auxiliary electrode 150 of the antenna module 100 of Embodiment 1. In FIG. 8, descriptions of elements that overlap with those of the antenna module 100 are not repeated.

Referring to FIG. 8, the auxiliary electrode 150A of the antenna module 100C is a planar electrode having a substantially T-shaped form when viewed in plan from the Z-axis direction. When viewed in plan from the normal direction of the dielectric substrate 130, the dimension in the Y-axis direction of a portion (first portion) of the auxiliary electrode 150A that protrudes from the radiating element 121 is greater than the dimension in the Y-axis direction of a portion (second portion) of the auxiliary electrode 150A that overlaps the radiating element 121.

If the overlapping area between the auxiliary electrode 150A and the radiating element 121 becomes large, the influence on the impedance between the radiating element 121 and the feed line 140 may increase. Therefore, by reducing the dimension of the portion of the auxiliary electrode 150A that overlaps the radiating element 121, it is possible to reduce the impact of impedance mismatch associated with the addition of the auxiliary electrode 150A.

Furthermore, by setting the portion that protrudes from the radiating element 121 to be within the same dimensional range as that of the auxiliary electrode 150 of the antenna module 100, it is possible to improve the directivity of the antenna module when using radio-frequency signals in the sub-terahertz frequency band.

### Embodiment 5

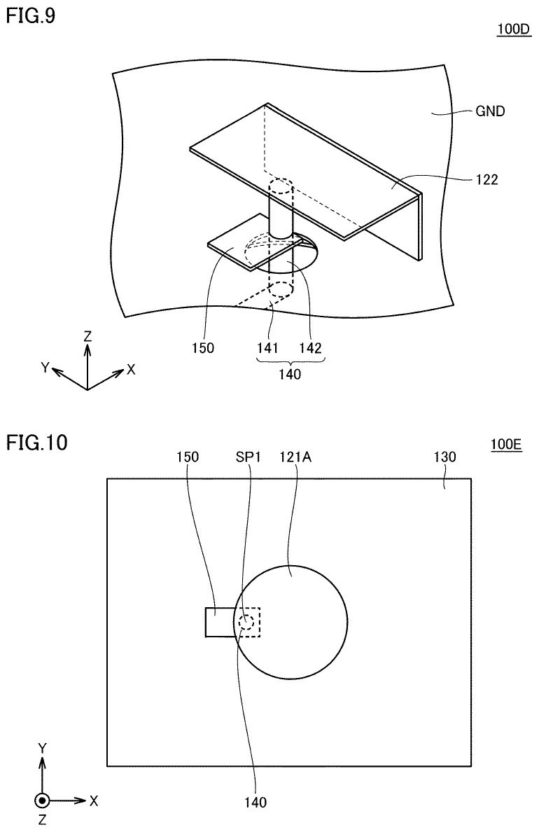

In Embodiment 5, a configuration in which an auxiliary electrode is disposed in a patch antenna having one end of a radiating element grounded will be described. FIG. 9 is a perspective view of an antenna module 100D according to Embodiment 5. The antenna module 100D includes a radiating element 122 in place of the radiating element 121 of the antenna module 100 of Embodiment 1. In FIG. 9, descriptions of elements that overlap with those of the antenna module 100 are not repeated.

Referring to FIG. 9, the radiating element 122 is a planar electrode, like the radiating element 121; however, the dimension of the radiating element 122 in the X-axis direction is about one-half of that of the radiating element 121. The radiating element 122 has an end portion farther from the feed point SP1 connected to the ground electrode GND. That is, the radiating element 122 is a so-called half patch antenna whose dimension in the polarization direction is set to a length of one-quarter wavelength. The auxiliary electrode 150 is connected to the via 142 of the feed line 140, which transmits a radio-frequency signal to the radiating element 122.

Also in the radiating element 122, electric field lines are generated from an end portion in the negative X-axis direction, serving as an open end, toward the ground electrode GND. Accordingly, by providing the auxiliary electrode 150, it is possible to guide electric field lines generated from the radiating element 122 to the ground electrode GND via the auxiliary electrode 150. As a result, it is possible to suppress the influence of surface waves when a radio-frequency signal in the sub-terahertz frequency band is used, thereby improving the directivity of the antenna module.

The “radiating element 122” of Embodiment 5 corresponds to the “first radiating element” of the present disclosure.

### Embodiment 6

In Embodiment 6 and Modifications 1 and 2, variations of the element shape of the radiating element will be described.

FIG. 10 is a plan view of an antenna module 100E according to Embodiment 6. The antenna module 100E includes a radiating element 121A in place of the radiating element 121 of the antenna module 100 of Embodiment 1.

The radiating element 121A has a substantially circular shape when viewed in plan from the normal direction of the dielectric substrate 130. The feed point SP1 is disposed at a position offset from the center of the radiating element 121A in the negative X-axis direction, and the auxiliary electrode 150 is connected to the feed line 140, which supplies a radio-frequency signal to the feed point SP1. The auxiliary electrode 150 protrudes from the radiating element 121A in the negative X-axis direction.

Even in the case of a patch antenna having such a circular-shaped radiating element, providing the auxiliary electrode at the via of the feed line makes it possible to improve the directivity of the antenna module.

The “radiating element 121A” of Embodiment 6 corresponds to the “first radiating element” of the present disclosure.

### (Modification 1)

FIG. 11 is a plan view of an antenna module 100F of Modification 1. The antenna module 100F includes a radiating element 121B in place of the radiating element 121 of the antenna module 100 of Embodiment 1.

When viewed in plan from the normal direction of the dielectric substrate 130, the radiating element 121B has a substantially cross-shaped form with protruding portions protruding along the X-and Y-axis directions. In other words, the radiating element 121B is configured such that the substantially square radiating element 121 of the antenna module 100 has notches formed at its four corners.

The feed point SP1 is disposed in the protruding portion extending in the negative X-axis direction. The auxiliary electrode 150 is connected to the feed line 140, which supplies a radio-frequency signal to the feed point SP1. The auxiliary electrode 150 protrudes from the radiating element 121B in the negative X-axis direction.

Even in the case of a patch antenna having such a cross-shaped radiating element, providing the auxiliary electrode at the via of the feed line makes it possible to improve the directivity of the antenna module. Furthermore, forming the notches in the radiating element allows adjustment of impedance mismatch associated with the disposition of the auxiliary electrode.

The “radiating element 121B” of Modification 1 corresponds to the “first radiating element” of the present disclosure.

### (Modification 2)

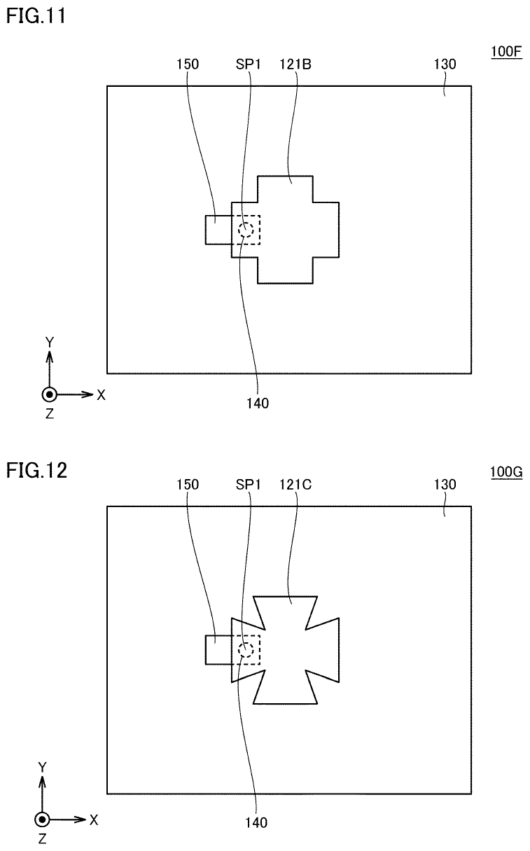

FIG. 12 is a plan view of an antenna module 100G of Modification 2. The antenna module 100G includes a radiating element 121C in place of the radiating element 121 of the antenna module 100 of Embodiment 1.

When viewed in plan from the normal direction of the dielectric substrate 130, the radiating element 121C has a substantially cross-shaped form with protruding portions protruding along the X-and Y-axis directions, like the radiating element 121B of Modification 1. However, in the radiating element 121C, each protruding portion has a tapered shape whose width becomes narrower toward the center of the element.

The auxiliary electrode 150 is connected to the feed line 140, which supplies a radio-frequency signal to the feed point SP1 disposed in the protruding portion protruding in the negative X-axis direction. The auxiliary electrode 150 protrudes from the radiating element 121B in the negative X-axis direction.

Even in the case of a patch antenna having such a cross-shaped radiating element, providing the auxiliary electrode at the via of the feed line makes it possible to improve the directivity of the antenna module. Furthermore, by giving the element a tapered shape, resonance occurs at multiple lengths of the radiating element, allowing the radiating element to operate at different frequencies. Therefore, by adopting a shape such as that of the radiating element 121C, it is possible to achieve a broader bandwidth than with the rectangular radiating element 121 of the antenna module 100.

The “radiating element 121C” of Modification 2 corresponds to the “first radiating element” of the present disclosure.

### Embodiment 7

In Embodiment 7, a configuration in which the features of the present disclosure are applied to a so-called dual-polarization-type antenna module capable of radiating radio waves in two different polarization directions will be described.

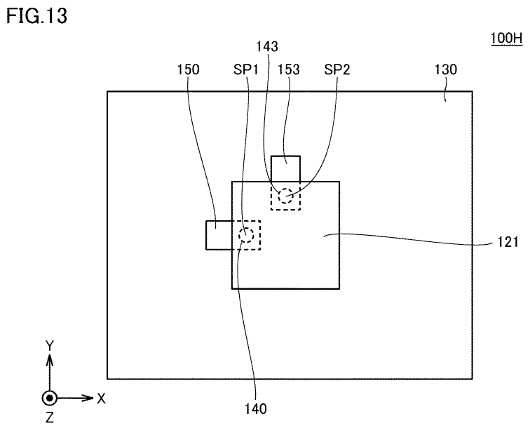

FIG. 13 is a plan view of an antenna module 100H according to Embodiment 7. The antenna module 100H further includes a feed line 143 and an auxiliary electrode 153 in addition to the configuration of the antenna module 100 of Embodiment 1. In FIG. 13, descriptions of elements that overlap with those of the antenna module 100 are not repeated.

The feed line 143 is connected to the radiating element 121 at a feed point SP2 disposed at a position offset from the center of the radiating element 121 in the positive Y-axis direction. By supplying a radio-frequency signal to the radiating element 121 through the feed line 143, radio waves polarized in the Y-axis direction are radiated in the positive Z-axis direction.

The auxiliary electrode 153 is a planar electrode connected to the feed line 143. Like the auxiliary electrode 151, the auxiliary electrode 153 is disposed on the feed line 143 between the radiating element 121 and the ground electrode GND. The auxiliary electrode 153 extends in the positive Y-axis direction from the point where it is connected to the feed line 143, and protrudes from the radiating element 121 toward the positive Y-axis direction.

With this configuration, it is possible to improve the directivity of radio waves polarized in the Y-axis direction, in addition to radio waves polarized in the X-axis direction.

The “feed line 143” of Embodiment 7 corresponds to a “second feed line” of the present disclosure. The “auxiliary electrode 153” of Embodiment 7 corresponds to a “fourth electrode” of the present disclosure. The “Y-axis direction” of Embodiment 7 corresponds to a “third direction” of the present disclosure.

### Embodiment 8

In Embodiment 8, a configuration in which the features of the present disclosure are applied to a so-called dual-band-type antenna module capable of radiating radio waves in two different frequency bands will be described.

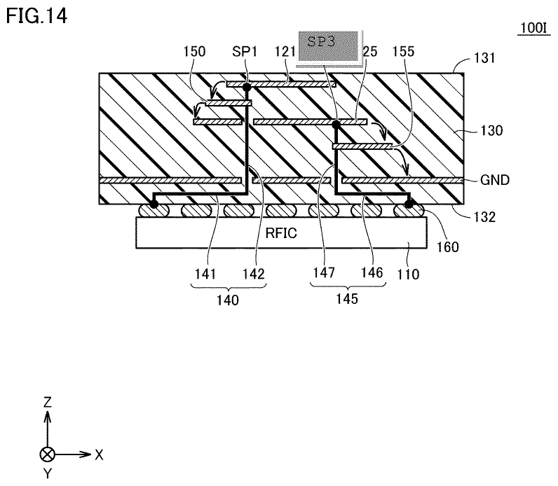

FIG. 14 is a side transparent view of an antenna module 100I according to Embodiment 8. The antenna module 100I further includes, in addition to the configuration of the antenna module 100 of Embodiment 1, a radiating element 125, a feed line 145, and an auxiliary electrode 155. In FIG. 14, descriptions of elements that overlap with those of the antenna module 100 are not repeated.

Referring to FIG. 14, the radiating element 125 is disposed within the dielectric substrate 130 between the auxiliary electrode 150 and the ground electrode GND, facing the radiating element 121 and the ground electrode GND. The radiating element 125 may have a substantially square shape when viewed in plan from the normal direction of the dielectric substrate 130, and is disposed such that the center of the radiating element 121 overlaps the center of the radiating element 125.

The size of the radiating element 125 is greater than the size of the radiating element 121. Therefore, the frequency of radio waves radiated from the radiating element 125 is lower than the frequency of radio waves radiated from the radiating element 121.

A radio-frequency signal is supplied from the RFIC 110 to a feed point SP3 of the radiating element 125 through the feed line 145. The feed line 145 includes a wiring pattern 146 extending from the solder bump 160 in the X-axis direction, and a via 147 extending from the end portion of the wiring pattern 146 in the Z-axis direction. The via 147 penetrates the ground electrode GND and is connected to the feed point SP3 of the radiating element 125. The feed point SP3 is offset from the center of the radiating element 125 in the positive X-axis direction (fourth direction). From the radiating element 125, radio waves polarized in the X-axis direction are radiated in the Z-axis direction.

The auxiliary electrode 155 is a planar electrode having a rectangular shape. The auxiliary electrode 155 is connected to the via 147 of the feed line 145. The auxiliary electrode 155 extends in the positive X-axis direction from the point where it is connected to the via 147 and protrudes from the end portion of the radiating element 125 toward the positive X-axis direction.

With this configuration, it is possible to improve the directivity of radio waves radiated from the radiating element 125, in addition to radio waves radiated from the radiating element 121.

The “radiating element 125” of Embodiment 8 corresponds to a “second radiating element” of the present disclosure. The “feed line 145” of Embodiment 8 corresponds to a “third feed line” of the present disclosure. The “auxiliary electrode 155” of Embodiment 8 corresponds to a “fifth electrode” of the present disclosure.

### Embodiment 9

In Embodiment 9, a configuration in which a grounding member or a grounding structure for reducing the influence of surface waves is disposed around the radiating element will be described.

FIG. 15 is a perspective view of an antenna module 100J according to Embodiment 9. The antenna module 100J further includes a grounding member 170 in addition to the configuration of the antenna module 100 of Embodiment 1. In FIG. 15, descriptions of elements that overlap with those of the antenna module 100 are not repeated.

In the example of the antenna module 100J illustrated in FIG. 15, the grounding member 170 is a wall-shaped planar electrode that is disposed around the radiating element 121 so as to surround the radiating element 121 when viewed in plan from the normal direction of the dielectric substrate 130. The lower end portion of the grounding member 170 is connected to the ground electrode GND, and the upper end portion of the grounding member 170 extends up to the main surface 131 of the dielectric substrate 130.

Note that the grounding member 170 is not limited to a planar electrode as in FIG. 15. For example, the grounding member 170 may have a configuration in which multiple vias are disposed so as to surround the radiating element 121.

By disposing the grounding member 170 as above, it is possible to suppress the spreading of surface waves propagating along the surface of the dielectric substrate 130, as compared with when the grounding member 170 is not provided. This enables the auxiliary electrode 150 to be made smaller in size.

### Embodiment 10

In Embodiment 10, a configuration in which an auxiliary electrode is additionally provided in a direction opposite to the feed point of the radiating element will be described.

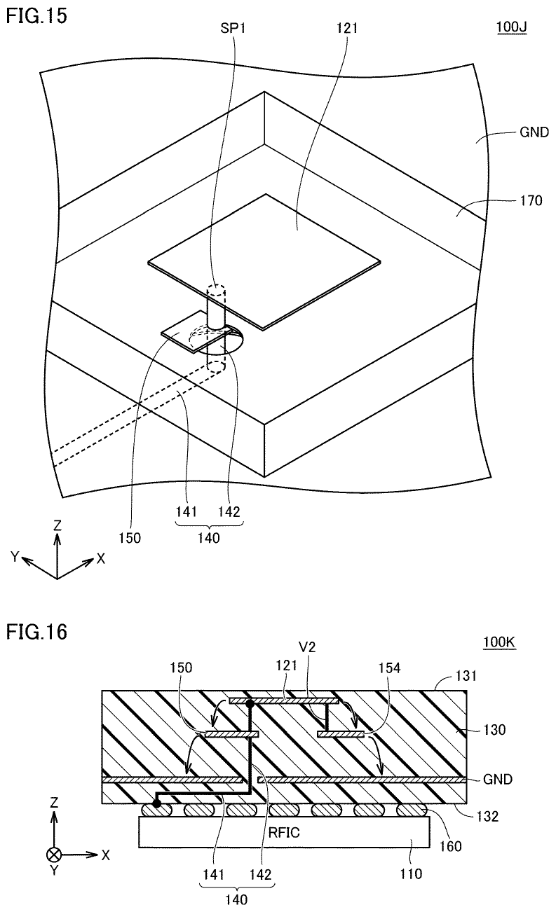

FIG. 16 is a side transparent view of an antenna module 100K according to Embodiment 10. The antenna module 100K further includes an auxiliary electrode 154 and a via V2 in addition to the configuration of the antenna module 100 of Embodiment 1. In FIG. 16, descriptions of elements that overlap with those of the antenna module 100 are not repeated.

The via V2 is connected to the radiating element 121 at a position offset from the center of the radiating element 121 in a direction opposite to the feed point SP1 (the positive X-axis direction). The via V2 extends in a direction from the radiating element 121 toward the ground electrode GND. The auxiliary electrode 154 is connected to the lower end portion of the via V2.

The auxiliary electrode 154 is a rectangular planar electrode, and is disposed in a layer between the radiating element 121 and the ground electrode GND. The auxiliary electrode 154 extends toward the positive X-axis direction (fifth direction) from the position where it is connected to the via V2. When viewed in plan from the normal direction of the dielectric substrate 130, the auxiliary electrode 154 protrudes from the end portion of the radiating element 121 toward the positive X-axis direction. Due to the auxiliary electrode 154, part of the electric field lines generated from the end portion in the positive X-axis direction of the radiating element 121 reach the ground electrode GND via the auxiliary electrode 154.

Depending on the required specifications, it may also be necessary for the electric field lines generated from the end portion in the positive X-axis direction of the radiating element 121 to be coupled to the ground electrode GND at a position closer to the radiating element 121. In such a case, by disposing the auxiliary electrode 154 on the opposite side of the auxiliary electrode 150, it is possible to guide the electric field lines to a position closer to the radiating element 121 than in the case where the auxiliary electrode 154 is not provided.

By appropriately adjusting the protrusion amounts of the auxiliary electrode 150 and the auxiliary electrode 154 from the radiating element 121, their distances (heights) from the ground electrode GND, and their element widths in the Y-axis direction, it is possible to adjust the balance of electric field lines generated in the positive and negative X-axis directions. This enables improvement of the directivity of radio waves radiated from the radiating element 121.

The “auxiliary electrode 154” of Embodiment 10 corresponds to a “sixth electrode” of the present disclosure. The “via V2” of Embodiment 10 corresponds to a “second via” of the present disclosure.

### Embodiment 11

In Embodiment 11, a configuration in which a dielectric lens for concentrating radio waves is disposed on the dielectric substrate will be described.

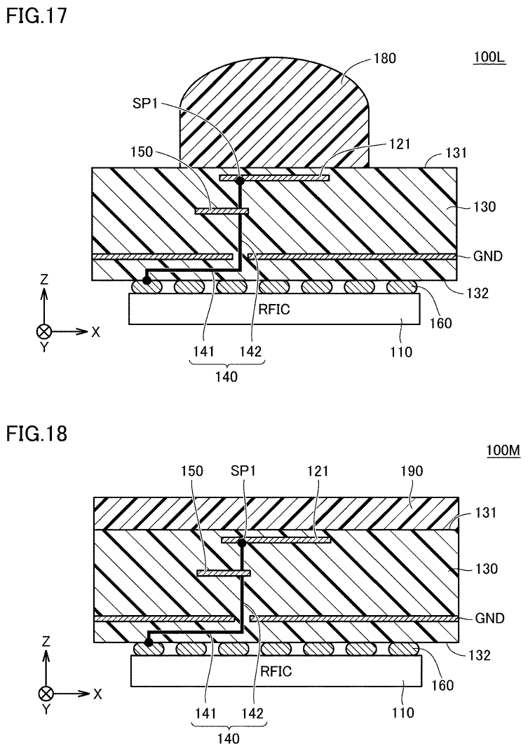

FIG. 17 is a side transparent view of an antenna module 100L according to Embodiment 11. The antenna module 100L further includes a dielectric lens 180 in addition to the configuration of the antenna module 100 of Embodiment 1. In FIG. 17, descriptions of elements that overlap with those of the antenna module 100 are not repeated.

Referring to FIG. 17, the dielectric lens 180 is a dielectric member having a curved convex portion protruding in the positive Z-axis direction. The dielectric lens 180 is disposed on the main surface 131 of the dielectric substrate 130 and covers the radiating element 121 when viewed in plan from the normal direction of the dielectric substrate 130. The convex portion of the dielectric lens 180 is formed in a spherical shape or an aspherical shape, and has a function of concentrating radio waves at a specific focal position by utilizing refraction of the radio waves caused by a difference in dielectric constant at the curved surface.

It is possible to adjust the focal position by varying the dielectric constant of the dielectric lens 180. Note that, due to differences in dielectric constant between the dielectric lens 180 and the dielectric substrate 130 and between the dielectric lens 180 and space (air), reflection of radio waves may occur at the interfaces. Therefore, when materials with small differences in dielectric constant are used, it is possible to reduce reflection loss occurring at the interfaces.

On the other hand, when a material with a relatively high dielectric constant is used for the dielectric lens 180, the effective wavelength within the dielectric lens 180 becomes shorter and the refractive index at the interfaces becomes greater. This enables size reduction, as compared with when a material having a relatively low dielectric constant is used.

Radio-frequency signals in the sub-terahertz frequency band tend to make it more difficult to secure antenna gain, as compared with signals in lower frequency bands. Therefore, by disposing the dielectric lens 180 as above, the radiated radio waves are concentrated, thereby increasing the antenna gain.

At this time, if the beam direction of radio waves radiated from the radiating element 121 is tilted from the normal direction of the dielectric substrate 130, it may be difficult to properly concentrate the radio waves at the desired position by the dielectric lens 180. Therefore, by disposing the auxiliary electrode 150 to adjust the beam direction, it is possible to increase the degree of concentration of the antenna gain.

### Embodiment 12

In Embodiment 12, a configuration in which a dielectric member or dielectric layer different from the dielectric substrate is disposed on the dielectric substrate in order to adjust the frequency band will be described.

FIG. 18 is a side transparent view of an antenna module 100M according to Embodiment 12. The antenna module 100M further includes a dielectric member 190 disposed on the main surface 131 of the dielectric substrate 130 in addition to the configuration of the antenna module 100 of Embodiment 1. In FIG. 18, descriptions of elements that overlap with those of the antenna module 100 are not repeated.

The dielectric member 190 has a dielectric constant different from that of the dielectric substrate 130, and is disposed over the entire main surface 131. That is, when viewed in plan from the normal direction of the dielectric substrate 130, the dielectric member 190 covers the radiating element 121.

Surface waves of the electric field propagating along the surface of the dielectric substrate 130 are affected by the dielectric constant of the dielectric member constituting the dielectric substrate 130. When the dielectric constant of the substrate is relatively high, the spreading of the surface waves becomes greater than in the case where the dielectric constant is low.

Therefore, by using, as the dielectric member 190, a material having a dielectric constant higher than that of the dielectric substrate 130, it is possible to increase the spreading of the surface waves, thereby widening the frequency band.

On the other hand, when the frequency band becomes excessively wide due to the influence of the surface waves and it becomes unable to secure a desired antenna gain, by using, as the dielectric member 190, a material having a dielectric constant lower than that of the dielectric substrate 130, it is possible to reduce the influence of the surface waves, thereby increasing the antenna gain.

The dielectric constant of the dielectric member 190 is appropriately selected in consideration of the required frequency bandwidth, antenna gain, the dielectric constant of the dielectric member used for the dielectric substrate 130, and the like.

Again, it is possible to improve the directivity of the antenna module by providing the auxiliary electrode at the via of the feed line.

### [Modes]

It will be understood by those skilled in the art that the above-described exemplary embodiments are specific examples of the following modes.

(Item 1) An antenna module according to one mode includes a dielectric substrate, a first radiating element having a planar shape, a ground electrode, a first feed line, and a first electrode having a planar shape. The dielectric substrate has a first main surface and a second main surface facing each other. The first radiating element is disposed in or on the dielectric substrate. The ground electrode is disposed on the second main surface side of the dielectric substrate relative to the first radiating element, facing the first radiating element. The first feed line transmits a radio-frequency signal to a first feed point of the first radiating element. The first electrode is connected to the first feed line and is disposed between the first radiating element and the ground electrode. The first feed point is disposed at a position offset from a center of the first radiating element in a first direction. When viewed in plan from a normal direction of the dielectric substrate, the first electrode protrudes from the first radiating element toward the first direction.

(Item 2) In the antenna module according to Item 1, a protrusion amount of the first electrode from the first radiating element is less than or equal to one-half of a dimension of the first radiating element in the first direction.

(Item 3) In the antenna module according to Item 1 or 2, the first electrode includes a first portion protruding from the first radiating element and a second portion overlapping the first radiating element when viewed in plan from the normal direction of the dielectric substrate. When a second direction is defined as a direction orthogonal to the first direction along a surface of the first electrode, a dimension of the first portion in the second direction is one-tenth or more and two-thirds or less of a dimension of the first radiating element in the first direction.

(Item 4) In the antenna module according to Item 3, in the first electrode, the dimension of the first portion in the second direction is greater than a dimension of the second portion in the second direction.

(Item 5) The antenna module according to any one of Items 1 to 4 further includes a second electrode connected between the first electrode and the ground electrode in the first feed line. When viewed in plan from the normal direction of the dielectric substrate, the second electrode protrudes from the first electrode toward the first direction.

(Item 6) The antenna module according to any one of Items 1 to 4 further includes a first via extending from the first electrode toward the ground electrode, and a third electrode having a planar shape connected to the first via. When viewed in plan from the normal direction of the dielectric substrate, the third electrode protrudes from the first electrode toward the first direction.

(Item 7) The antenna module according to any one of Items 1 to 6 further includes a second feed line, and a fourth electrode having a planar shape. The second feed line supplies a radio-frequency signal to a second feed point disposed at a position offset from the center of the first radiating element in a third direction. The fourth electrode is connected to the second feed line. The third direction intersects the first direction. The fourth electrode is connected between the first radiating element and the ground electrode in the second feed line. When viewed in plan from the normal direction of the dielectric substrate, the fourth electrode protrudes from the first radiating element toward the third direction.

(Item 8) The antenna module according to any one of Items 1 to 6 further includes a second radiating element, a third feed line, and a fifth electrode. The second radiating element is disposed between the first electrode and the ground electrode, and, when viewed in plan from the normal direction of the dielectric substrate, overlaps the first radiating element. The third feed line transmits a radio-frequency signal to a third feed point disposed at a position offset from a center of the second radiating element in a fourth direction. The fifth electrode is connected to the third feed line and is disposed between the second radiating element and the ground electrode. A dimension of the second radiating element is greater than a dimension of the first radiating element. When viewed in plan from the normal direction of the dielectric substrate, the fifth electrode protrudes from the second radiating element toward the fourth direction.

(Item 9) The antenna module according to any one of Items 1 to 6 further includes a second via, and a sixth electrode having a planar shape. The second via is connected to the first radiating element at a position offset from the center of the first radiating element in a fifth direction opposite to the first direction. The sixth electrode is connected to the second via and is disposed between the first radiating element and the ground electrode. When viewed in plan from the normal direction of the dielectric substrate, the sixth electrode protrudes from the first radiating element toward the fifth direction.

(Item 10) The antenna module according to any one of Items 1 to 9 further includes a grounding member disposed around the first radiating element so as to surround the first radiating element when viewed in plan from the normal direction of the dielectric substrate, and electrically coupled to the ground electrode.

(Item 11) The antenna module according to any one of Items 1 to 10 further includes a dielectric member disposed on the first main surface of the dielectric substrate so as to cover the first radiating element when viewed in plan from the normal direction of the dielectric substrate. A dielectric constant of the dielectric member is different from a dielectric constant of the dielectric substrate.

(Item 12) The antenna module according to any one of Items 1 to 10 further includes a dielectric lens disposed on the first main surface of the dielectric substrate and having a convex shape in the normal direction. When viewed in plan from the normal direction of the dielectric substrate, the dielectric lens covers the first radiating element.

(Item 13) In the antenna module according to Item 1, the first radiating element has a substantially rectangular shape when viewed in plan from the normal direction of the dielectric substrate.

(Item 14) In the antenna module according to Item 1,when a second direction is defined as a direction orthogonal to the first direction along a surface of the first electrode, the first radiating element has a substantially cross-shaped form with protruding portions protruding along the first direction and the second direction when viewed in plan from the normal direction of the dielectric substrate.

(Item 15) In the antenna module according to Item 14, in the radiation element, the protruding portions have a tapered shape whose width becomes narrower toward the center of the first radiating element.

(Item 16) In the antenna module according to Item 1, the first radiating element has a substantially circular shape when viewed in plan from the normal direction of the dielectric substrate.

(Item 17) In the antenna module according to Item 1, an end portion of the first radiating element on a side opposite to the first direction from the center of the first radiating element is connected to the ground electrode.

(Item 18) The antenna module according to any one of Items 1 to 17 further includes a third radiating element having a planar shape, a fourth feed line, and a seventh electrode having a planar shape. The third radiating element is disposed adjacent to the first radiating element when viewed in plan from the normal direction of the dielectric substrate, and is disposed facing the ground electrode. The fourth feed line transmits a radio-frequency signal to a fourth feed point of the third radiating element. The seventh electrode is connected to the fourth feed line and is disposed between the third radiating element and the ground electrode. The fourth feed point is disposed at a position offset from a center of the third radiating element in the first direction. When viewed in plan from the normal direction of the dielectric substrate, the seventh electrode protrudes from the third radiating element toward the first direction.

(Item 19) The antenna module according to any one of Items 1 to 18 further includes a feed circuit that supplies a radio-frequency signal to each radiating element.

(Item 20) A communication device according to one mode is equipped with the antenna module according to any one of Items 1 to 19.

The embodiments disclosed herein should be regarded illustrative in all respects and not restrictive. The scope of the present invention is defined not by the description of the above embodiments, but by the claims, and it is intended to encompass all modifications within the meaning and scope equivalent to the claims.

### REFERENCE SIGNS LIST

10 communication device; 100, 100A to 100M, 100X antenna modules; 110 RFIC; 111A to 111D, 113A to 113D, 117 switches; 112AR to 112DR low-noise amplifiers; 112AT to 112DT power amplifiers; 114A to 114D attenuators; 115A to 115D phase shifters; 116 signal combiner/splitter; 118 mixer; 119 amplification circuit; 120 antenna device; 121, 121A to 121C, 122, 125 radiating elements; 130 dielectric substrate; 131, 132 main surfaces; 140, 143, 145 feed lines; 141, 146 wiring patterns; 142, 147, V1, V2 vias; 151 to 155, 150A auxiliary electrodes; 160 solder bumps; 170 grounding member; 180 dielectric lens; 190 dielectric member; 200 BBIC; GND ground electrode; and SP1 to SP3 feed points.

1. An antenna module comprising:
a dielectric substrate having a first main surface and a second main surface facing each other;
a first radiating element having a planar shape disposed in or on the dielectric substrate;
a ground electrode disposed on the second main surface of the dielectric substrate and faces the first radiating element;
a first feed line configured to transmit a radio-frequency signal to a first feed point of the first radiating element; and
a first electrode having a planar shape connected to the first feed line and disposed between the first radiating element and the ground electrode, wherein
the first feed point is disposed at a position offset from a center of the first radiating element in a first direction; and
when viewed in plan from a normal direction of the dielectric substrate, the first electrode protrudes from the first radiating element toward the first direction.

2. The antenna module according to claim 1, wherein a protrusion amount of the first electrode from the first radiating element is less than or equal to one-half of a dimension of the first radiating element in the first direction.

3. The antenna module according to claim 1, wherein:
when viewed in plan from the normal direction of the dielectric substrate, the first electrode includes:
a first portion protruding from the first radiating element; and
a second portion overlapping the first radiating element, and
when a second direction is defined as a direction orthogonal to the first direction along a surface of the first electrode, a dimension of the first portion in the second direction is one-tenth or more and two-thirds or less of a dimension of the first radiating element in the first direction.

4. The antenna module according to claim 3, wherein, in the first electrode, the dimension of the first portion in the second direction is greater than a dimension of the second portion in the second direction.

5. The antenna module according to claim 1, further comprising:
a second electrode connected between the first electrode and the ground electrode in the first feed line,
wherein, when viewed in plan from the normal direction of the dielectric substrate, the second electrode protrudes from the first electrode toward the first direction.

6. The antenna module according to claim 1, further comprising:
a first via extending from the first electrode toward the ground electrode; and
a third electrode having a planar shape connected to the first via,
wherein, when viewed in plan from the normal direction of the dielectric substrate, the third elect rode protrudes from the first electrode toward the first direction.

7. The antenna module according to claim 1, further comprising:
a second feed line configured to supply a radio-frequency signal to a second feed point disposed at a position offset from the center of the first radiating element in a third direction; and
a fourth electrode having a planar shape connected to the second feed line,
wherein the third direction intersects the first direction;
the fourth electrode is connected between the first radiating element and the ground electrode in the second feed line; and
when viewed in plan from the normal direction of the dielectric substrate, the fourth electrode protrudes from the first radiating element toward the third direction.

8. The antenna module according to claim 1, further comprising:
a second radiating element disposed between the first electrode and the ground electrode, and, when viewed in plan from the normal direction of the dielectric substrate, overlaps the first radiating element;
a third feed line configured to transmit a radio-frequency signal to a third feed point disposed at a position offset from a center of the second radiating element in a fourth direction; and
a fifth electrode connected to the third feed line and disposed between the second radiating element and the ground electrode,
wherein a dimension of the second radiating element is greater than a dimension of the first radiating element; and
when viewed in plan from the normal direction of the dielectric substrate, the fifth electrode protrudes from the second radiating element toward the fourth direction.

9. The antenna module according to claim 1, further comprising:
a second via connected to the first radiating element at a position offset from the center of the first radiating element in a fifth direction opposite to the first direction; and
a sixth electrode having a planar shape connected to the second via and disposed between the first radiating element and the ground electrode,
wherein, when viewed in plan from the normal direction of the dielectric substrate, the sixth electrode protrudes from the first radiating element toward the fifth direction.

10. The antenna module according to claim 1, further comprising a grounding structure disposed around the first radiating element so as to surround the first radiating element when viewed in plan from the normal direction of the dielectric substrate, and electrically coupled to the ground electrode.

11. The antenna module according to claim 1, further comprising:
a dielectric layer disposed on the first main surface of the dielectric substrate so as to cover the first radiating element when viewed in plan from the normal direction of the dielectric substrate,
wherein a dielectric constant of the dielectric layer is different from a dielectric constant of the dielectric substrate.

12. The antenna module according to claim 1, further comprising:
a dielectric lens disposed on the first main surface of the dielectric substrate and having a convex shape in the normal direction of the dielectric substrate,
wherein, when viewed in plan from the normal direction of the dielectric substrate, the dielectric lens covers the first radiating element.

13. The antenna module according to claim 1, wherein the first radiating element has a substantially rectangular shape when viewed in plan from the normal direction of the dielectric substrate.

14. The antenna module according to claim 1, wherein:
when a second direction is defined as a direction orthogonal to the first direction along a surface of the first electrode,
the first radiating element has a substantially cross-shaped form with protruding portions protruding along the first direction and the second direction when viewed in plan from the normal direction of the dielectric substrate.

15. The antenna module according to claim 14, wherein, in the radiation element, the protruding portions have a tapered shape whose width becomes narrower toward the center of the first radiating element.

16. The antenna module according to claim 1, wherein the first radiating element has a substantially circular shape when viewed in plan from the normal direction of the dielectric substrate.

17. The antenna module according to claim 1, wherein an end portion of the first radiating element on a side opposite to the first direction from the center of the first radiating element is connected to the ground electrode.

18. The antenna module according to claim 1, further comprising:
a third radiating element having a planar shape disposed adjacent to the first radiating element when viewed in plan from the normal direction of the dielectric substrate, and is disposed facing the ground electrode;
a fourth feed line configured to transmit a radio-frequency signal to a fourth feed point of the third radiating element; and
a seventh electrode having a planar shape connected to the fourth feed line and disposed between the third radiating element and the ground electrode,
wherein the fourth feed line is disposed at a position offset from a center of the third radiating element in the first direction; and
when viewed in plan from the normal direction of the dielectric substrate, the seventh electrode protrudes from the third radiating element toward the first direction.

19. The antenna module according to claim 1, further comprising a feed circuit configured to supply a radio-frequency signal to each radiating element.

20. A communication device equipped with the antenna module according to claim 1.
